(19) United States
(12) Patent Application Publication
(10) Pub. No.: US 2020/0380091 A1
(43) Pub. Date: Dec. 3, 2020

(54) METHOD, ELECTRONIC DEVICE, COMPUTER PROGRAM, AND SYSTEM FOR SECURE DATA SHARING USING BLOCKCHAIN NETWORK

(71) Applicant: Samsung Electronics Co., Ltd., Suwon-si (KR)

(72) Inventors: Suchi BANSAL, Alwar (IN); Rohit BANSAL, Alwar (IN)

(21) Appl. No.: 16/889,072

(22) Filed: Jun. 1, 2020

(30) Foreign Application Priority Data
May 30, 2019 (IN) 201941021587

(51) Int. Cl. G06F 21/10; G06F 16/18; G06F 21/62; H04L 9/00; H04L 9/06; H04L 9/32

(52) U.S. Cl. CPC G06F 21/10; G06F 16/1865; G06F 21/6245; H04L 2209/38; H04L 9/0643; H04L 9/3236; H04L 9/006

(57) ABSTRACT

A method for protecting and sharing a data file using a block chain network, and an apparatus therefor are provided. The method includes encoding, at an electronic device in a blockchain network, at least one portion of data to be transmitted to another electronic device, generating a packet based on the data including the encoded at least one portion, and transmitting the packet from the electronic device to the other electronic device, wherein a transaction block recorded on the blockchain network is updated based on a transaction information regarding the transmission of the packet. The transaction information includes forward-lock information for indicating whether the at least one portion of the data is forward-locked.

### CROSS-REFERENCE TO RELATED APPLICATION(S)

This application is based on and claims priority under 35 U.S.C. § 119 of an Indian patent application number 201941021587, filed on May 30, 2019, in the Indian Patent Office, the disclosure of which is incorporated by reference herein in its entirety.

### BACKGROUND

### 1. Field

The disclosure relates to protecting and sharing a data file using a blockchain network. More particularly, the disclosure relates to protecting and sharing a data file having one or more encoded portions using a blockchain network.

### 2. Description of Related Art

With the development of the Internet technology, massive amounts of data is being continuously managed by networks involving computers, servers and other connected devices. In order to effectively manage the massive amounts of data over the network, centralized and decentralized data management methods are being employed. In centralized data sharing, all the data are stored in a single data center or a cloud storage system and external unified data access interface is provided to the users to access the stored data. Data center or cloud storage system can provide secure access to the stored data to the users through a unified resource link (URL). Further, the data stored in the data center or the cloud system can be protected by using a key or password, user device authentication, authorization, and other access control mechanisms to control user access to the data. However, even after the use of advanced data protection and access control mechanisms such centralized data storage and data sharing lead to data breaches and fraudulent use of URLs by unauthorized users. Furthermore, using existing centralized data sharing systems, it is difficult to provide data access to selected portions of a data file to selected users.

Recent developments in blockchain technology allow the users to utilize the blockchain network for sharing a variety of information. The blockchain technology is a new distributed infrastructure and computational paradigm that uses blockchain data structures to validate and store data, uses distributed node consensus algorithms to generate and update data, and uses cryptography to ensure the security of data transmission and access. Blockchain technology collectively maintains a reliable database through decentralization and trustworthiness to solve transaction trust and security issues. Further, a blockchain may be used as a public ledger to store and share any type of information. Although, primarily used for financial transactions, a blockchain can store any type of information including various types of stored data, information related to any links to any external centralized or decentralized stored data. A decentralized scheme transfers authority and trust to a decentralized network and enables its nodes to continuously and sequentially record their transactions on a public “block”, generating a unique “chain” referred to as a blockchain. Blockchain employs cryptography, via hash codes, to secure an authentication of a transaction source and removes a central intermediary.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and method for protecting and sharing a data file using a block chain network.

Additional aspects will be set forth in part in the description which follows and, in part, will be apparent from the description, or may be learned by practice of the presented embodiments.

In accordance with an aspect of the disclosure, a method is provided. The method includes encoding, at an electronic device in a blockchain network, at least one portion of data to be transmitted to another electronic device, generating a packet based on the data including the encoded at least one portion, and transmitting the packet from the electronic device to the other electronic device, wherein a transaction block recorded on the blockchain network is updated based on a transaction information regarding the transmission of the packet, and wherein the transaction information comprises forward-lock information for indicating whether the at least one portion of the data is forward-locked.

In accordance with another aspect of the disclosure, a method is provided. The method includes receiving, at an electronic device in a blockchain network, a packet transmitted from another electronic device, obtaining, from a transaction block recorded on the blockchain network, transaction information regarding the transmission of the packet, decoding, based on the transaction information, encoded at least one portion of data from the packet, and performing an action on the at least one portion of the data based on a result of the decoding, wherein the transaction information comprises forward-lock information for indicating whether the at least one portion of the data is forward-locked.

In accordance with another aspect of the disclosure, a method for protecting a data file in a blockchain network is provided. The blockchain network includes a number of nodes or electronic devices in communication with each other for secure transfer of data. The method of protecting the data file may include selecting the data file using a first electronic device and detecting a user input to protect at least one portion of the data file and at least one data property of the data file. Further, the selected portion of the data file and the data property of the data file may be encoded using the first electronic device based on the user input. According to an embodiment, one or more data packets comprising the encoded portion of the data files and the encoded data property of the data file may be generated. The data packets generated by the first electronic device may be then sent to the blockchain network. A second electronic device connected to the blockchain network can access the encrypted data packets and decode the encoded portions of the data file.

In accordance with another aspect of the disclosure, the at least one data property of the data file is provided. The data property of the data file includes a forward or share counter to count a number of times the data file is forwarded or shared in the blockchain network, a forward lock to restrict the at least one second electronic device for forwarding the data file with other electronic devices in the blockchain network, a share lock to restrict the at least one second electronic device for sharing the data file with other electronic devices in the blockchain network, and a spam indicator to indicate infelicitous or irrelevant or unsolicited content of the data file to the at least one second electronic device in the blockchain network and a file linker to link the data file in a file system for space optimization.

In an embodiment, encoding of the at least one portion of the data file and the at least one data property of the data file may be performed by generating a session key associated with the first electronic device and the at least one second electronic device, identifying the at least one portion of the data file to be encoded and the user input associated with the at least one portion of the data file, dividing the at least one portion of the data file into a number of sub-portions, shuffling the sub-portions and encoding the shuffled chunks of data file using the session key. According to an embodiment, encoding of the at least one data property of the data file may be enabled based on the user input. In one embodiment, the at least one data packet generated using the above disclosed method may include a group identifier of the first electronic device and the at least one second electronic device, a unique identifier of the first electronic device, a file type information of the data file, a hash value of the data file indicating the at least one portion of the data file, a flag indicating an enable or disable status of the at least one data property of the data file.

In accordance with an aspect of the disclosure, a method for receiving the data file and retrieving the at least one encoded portion of the data file from the blockchain network is provided. The method of retrieving the at least one encoded portion of the data file includes receiving, by the at least one second electronic device, the at least one data packet from the first electronic device, generating, by the at least one second electronic device, the session key associated with the first electronic device and the at least one second electronic device, decoding, by the at least one second electronic device, the at least one encoded portion of the encoded data file by shuffling the number of sub-portions based on the session key, determining, by the at least one second electronic device, whether the decoding of the at least one encoded portion of the encoded data file is successful and executing, by the at least one second electronic device, the at least one encoded portion of the encoded data file during runtime to retrieve the at least one portion of the data file in response to determining that decoding of the at least one encoded portion of the encoded data file is successful, or rejecting, by the at least one second electronic device, execution of the at least one encoded portion of the encoded data file in response to determining that decoding of the at least one encoded portion of the encoded data file is unsuccessful.

In accordance with another aspect of the disclosure, the method for receiving and retrieving the at least one encoded portion of the data file from the blockchain network is provided. The method includes detecting, by the at least one second electronic device, an action corresponding to the at least one data property of the data file, detecting, by the at least one second electronic device, a status of the at least one data property of the data file in the at least one data packet and allowing, by the at least one second electronic device, the action corresponding to the at least one data property of the data file in response to detecting the status of the at least one data property as enabled, or rejecting, by the at least one second electronic device, the action corresponding to the at least one data property of the data file in response to detecting the status of the at least one data property as disabled. In an embodiment, the action corresponding to the at least one data property of the data file may include a forwarding action and a sharing action on the data file. According to an embodiment, the users may be allowed to set a forward or share counter on the data file in response to performing the action using the second electronic device.

In accordance with another aspect of a disclosure, an electronic device for protecting a data file in a blockchain network is provided. The electronic device includes a memory storing the data file and at least one processor in communication with the memory. The at least one processor may further be configured to detect a user input to protect at least one portion of the data file and at least one data property of the data file, encode the at least one portion of the data file and the at least one data property of the data file based on the user input, generate at least one data packet comprising the at least one encoded portion of the data file and the at least one encoded data property of the encoded data file and send the at least one data packet with the blockchain network and at least one second electronic device in the blockchain network.

In accordance with another aspect of the disclosure, an electronic device for accessing the encoded data file in the blockchain network is provided. The electronic device includes a memory and at least one processor connected to the memory and configured to receive the at least one data packet corresponding to the encoded data file from a first electronic device in the blockchain network. The at least one processor may be further configured to generate a session key associated with the receiver electronic device(s) and the first electronic device, decode the at least one encoded portion of the encoded data file by shuffling the sub-portions in the at least one encoded portion of the encoded data file based on the session key, determine whether the decoding of the at least one encoded portion of the encoded data file is successful and execute the at least one encoded portion of the encoded data file during runtime to retrieve the at least one portion of the data file in response to determining that decoding of the at least one encoded portion of the encoded data file is successful, or reject execution of the at least one encoded portion of the encoded data file in response to determining that decoding of the at least one encoded portion of the encoded data file is unsuccessful.

In accordance with another aspect of the disclosure, a system for sharing a protected data file using the blockchain network is provided. The system includes the first electronic device configured to detect a user input to protect at least one portion of the data file and at least one data property of the data file, encode the at least one portion of the data file and the at least one data property of the data file based on the user input, generate at least one data packet comprising the at least one encoded portion of the data file and the at least one encoded data property of the encoded data file and send the at least one data packet with the blockchain network and at least one second electronic device in the blockchain network. The system may further include a second electronic device configured to receive the at least one data packet corresponding to the encoded data file from a first electronic device in the blockchain network in the memory, generate a session key associated with the receiver electronic device(s) and the first electronic device, decode the at least one encoded portion of the encoded data file by shuffling the sub-portions in the at least one encoded portion of the encoded data file based on the session key, determine whether the decoding of the at least one encoded portion of the encoded data file is successful and execute the at least one encoded portion of the encoded data file during runtime to retrieve the at least one portion of the data file in response to determining that decoding of the at least one encoded portion of the encoded data file is successful, or reject execution of the at least one encoded portion of the encoded data file in response to determining that decoding of the at least one encoded portion of the encoded data file is unsuccessful.

Other aspects advantages, and salient features of the disclosure will become apparent to those skilled in the art from the following detailed description, which, taken in conjunction with the annexed drawings discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a system for protecting a data file and sharing the protected data file using a blockchain network, according to an embodiment of the disclosure;

FIG. 1B illustrates a block diagram for explaining components of an electronic device configured to generate and share one or more encrypted data packets from a data file using a blockchain network, according to an embodiment of the disclosure;

FIG. 1C illustrates a block diagram for explaining components of a content encoder associated with the electronic device configured to encode at least one portion of a data file, according to an embodiment of the disclosure;

FIG. 2A illustrates a flowchart of a method according to an embodiment of the disclosure;

FIG. 2B illustrates a block diagram for explaining operations of a file hash generator to generate a file hash corresponding to a data file, according to an embodiment of the disclosure;

FIG. 3 illustrates a flow chart for explaining a method of sharing a protected data file using a blockchain network, according to an embodiment of the disclosure;

FIG. 4 illustrates a detailed flow chart for explaining a method of sharing a protected data file using a blockchain network, according to an embodiment of the disclosure;

FIG. 5 illustrates a timing diagram for explaining a sequence of operations for sharing a protected data file using a blockchain network, according to an embodiment of the disclosure;

FIG. 6 illustrates a flow chart for explaining operations at the receiver electronic device to retrieve the at least one portion of the data file, according to an embodiment of the disclosure;

FIG. 7 illustrates a block diagram for explaining operation of a receiver electronic device to retrieve at least one portion of a data file, according to an embodiment of the disclosure;

FIG. 8 illustrates an example use case of selective sharing of one or more portions of a video file using a blockchain network, according to an embodiment of the disclosure;

FIG. 9 illustrates an example use case of sharing a data file with at least one forward locked portion from a first electronic device to a user group having receiver electronic devices using a blockchain network, according to an embodiment of the disclosure;

FIG. 10 illustrates an example use case of selectively sharing one or more portions of a traffic violation video file to a plurality of users or receiver electronic devices using a blockchain network, according to an embodiment of the disclosure;

FIG. 11 illustrates an example use case of selectively sharing one or more portions of an image to a plurality of users or receiver electronic devices using a blockchain network, according to an embodiment of the disclosure;

FIG. 12 illustrates an example use case of selectively sharing one or more portions of a text page to a plurality of users or receiver electronic devices using a blockchain network, according to an embodiment of the disclosure;

FIG. 13 illustrates an example use case of spam management in a shared data file at a receiver electronic devices using a blockchain network, according to an embodiment of the disclosure; and

FIG. 14 illustrates an example use case of space management using a blockchain network, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Various blockchain-based methods may be employed for data sharing among nodes in a blockchain network. For example, a blockchain for file management and search system may share data from a node as a blockchain transaction to another node by using an IP address and port number associated with the node where the data is stored. The transaction information is recorded in the blockchain and it is difficult for an intruder to modify the data stored in the node without the consent of all the nodes sharing the transaction information. However, the above said method may only be utilized to share data between nodes and does not allow a node to select and share multiple portions in the data to selected nodes in the blockchain in a single transaction. Furthermore, the node receiving the data from the blockchain network is not prevented from storing and sharing the data to other users in the blockchain network. In addition, in the existing methods of blockchain technology for secure data sharing and access control, sharing of multiple encoded portions in a single file for selective access at multiple nodes in the blockchain network is not possible.

The proposed system and method addresses the above said problems, disadvantages and other shortcomings of the existing methods for data sharing and suggests a useful alternative to provide selective data sharing among nodes in a blockchain network.

Embodiments herein are to provide a method for protecting and sharing a data file in a blockchain network using an electronic device.

Embodiments herein are to provide a method for encoding and selective sharing of a number of encoded portions in a data file in a blockchain network using an electronic device.

Embodiments herein are to provide a method for accessing an encoded portion in a data file shared in a blockchain network using an electronic device.

Embodiments herein are to provide a method for forward locking an encoded portion in a data file shared in a blockchain network using an electronic device.

Embodiments herein are to provide a method for assigning a spam level to a data file shared in a blockchain network using an electronic device.

Embodiments herein are to provide a method for space optimization while sharing a data file in a blockchain network using an electronic device.

Embodiments herein are to provide a method for assigning a forward counter to a data file while sharing a data file in a blockchain network using an electronic device.

According to an embodiment, a system and methods of using electronic devices for sharing a protected data file using a blockchain network may be provided. Electronic devices may be nodes of a blockchain network, but are not limited thereto. An electronic device may function as a full-node in the blockchain network. An electronic device may function as a light-node in a blockchain network. One or more electronic devices may be further configured to generate a protected data file and share the protected data file to one or more nodes in the blockchain network. The nodes in the blockchain network receiving the protected data file may be further configured to decrypt the data file. In an embodiment, the electronic devices may be configured for sharing the protected data file and decrypting the protected data files received through the blockchain network. In one or more embodiments, the system enables the users to encrypt one or more portions in the data file and share with a specific group of users through the blockchain network. Furthermore, embodiments of the system enable forward tracking of all the transactions involving the data file performed using each electronic device in the blockchain network. The system may be further configured to update each forward transaction involving the data file in all previous blocks till the originator block in the blockchain network. Further, each electronic device in the system may store the details of a previous and a forward electronic device in the blockchain network. The system enables the users to block the forwarding of the data file sent to another electronic device through the blockchain network. The system enables the users to update a spam level associated with the data file at the nodes or at the electronic devices.

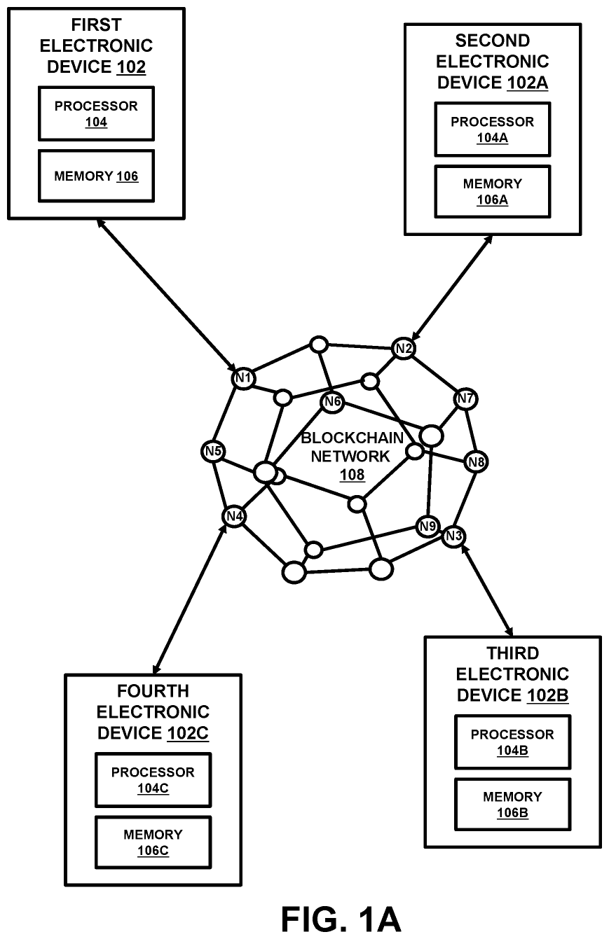

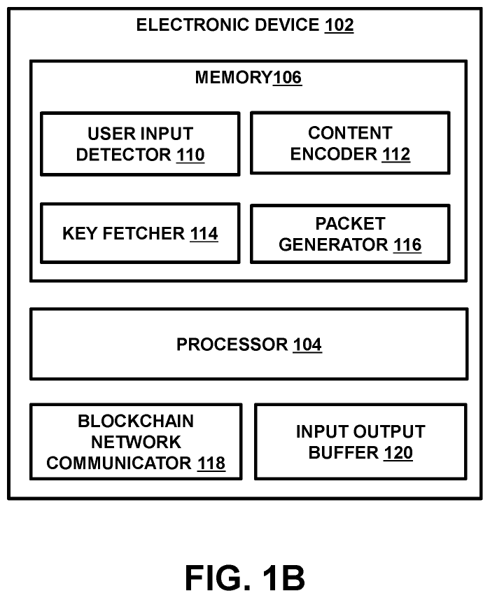

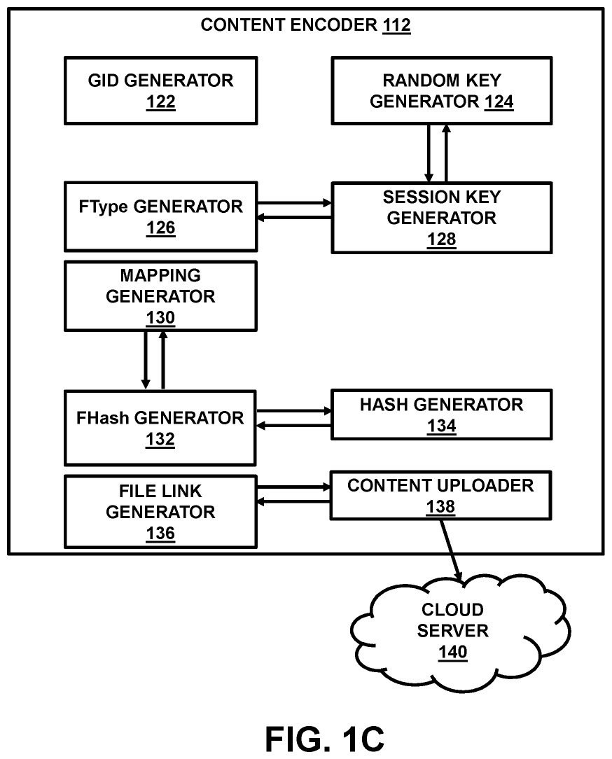

Referring now to the drawings, and more particularly to FIGS. 1A through 14, where similar reference characters denote corresponding features consistently throughout the figures, there are shown preferred embodiments.

FIG. 1A illustrates a system for protecting a data file and sharing the protected data file using a blockchain network, according to an embodiment of the disclosure.

Referring to FIG. 1A, the system may include a first electronic device 102 for protecting and sharing the one or more data files in a blockchain network 108. In an embodiment, the first electronic device 102 may include a memory 106 to store the data file and a processor 104 to perform a plurality of operations to generate at least one encrypted data packet from the data file for sharing through the blockchain network 108. The first electronic device 102 may be connected to the blockchain network 108 as a first node, n1, of the blockchain network 108. The system may further include other electronic devices such as a second electronic device 102a, a third electronic device 102b, a fourth electronic device 102c, etc. which may be configured to operate as nodes n2, n3, n4, etc., of the blockchain network 108. Each of the electronic devices 102a to 102c may be provided with memories 106a, 106b, and to 106c in communication with respective processors 104a, 104b, and 104c. The blockchain network 108 enables communication between the first electronic device 102 and the other electronic devices 102a, 102b, 102c, etc., in the blockchain network 108 to transfer the data file from the first electronic device 102 to any of the selected electronic devices 102a, 102b, 102c, etc., in the blockchain network 108.

FIG. 1B illustrates a block diagram for explaining components of an electronic device configured to generate and share one or more encrypted data packets from a data file using a blockchain network, according to an embodiment of the disclosure.

Referring to FIG. 1B, a first electronic device 102 may include a processor 104 and a memory 106. The memory 106 of the first electronic device 102 may store a user input detector 110 to detect at least one user input related to the at least one data file, a content encoder 112 to encode at least a portion of the data file and a key fetcher 114 to extract a public key of the second electronic device 102a or any other electronic devices 102a, 102b, 102c, etc., to which the first electronic device 102 is configured to send the at least one portion of the data file. The user input detector 110, content encoder 112, and key fetcher 114 may be executed by the processor 104. The key fetcher 114 may be configured to extract the public keys of the receiver electronic devices 102a, 102b, 102c, etc., from the blockchain network 108. The memory 106 of the first electronic device 102 may further include a packet generator 116 to generate one or more encrypted data packets from the encoded portions of the data file. The packet generator 116 may be executed by the processor 104. The user input detector 110, content encoder 112, key fetcher 114, and packet generator 116 are illustrated as being included in the memory 106, but are not limited thereto. For example, the user input detector 110, content encoder 112, key fetcher 114, and packet generator 116 may be stored outside of the memory 106 of the electronic device 102 and executed by the processor 104, or embodied in the processor 104. The first electronic device 102 may include a blockchain network communicator 118 to transfer the one or more encrypted data packets to the blockchain network 108. Further, the first electronic device 102 may transmit the one or more encrypted data packets to the blockchain network 108 based on an input output buffer 120.

FIG. 1C illustrates a block diagram for explaining components of a content encoder associated with the electronic device configured to encode at least one portion of a data file, according to an embodiment of the disclosure.

Referring to FIG. 1C, a content encoder 112 configured to receive a data file may include a group identification (GID) generator 122 to generate a group identification (GID) by encrypting a private key of the first electronic device 102 and public keys of one or more receiver electronic devices 102a, 102b, 102c, etc. selected at the first electronic device 102. The key fetcher 114 may collect the public keys of the one or more receiver electronic devices 102a, 102b, 102c, etc. and delivers them to the content encoder 112 for further processing. The content encoder 112 may include a random key generator 124 to generate a random key, a file type (FType) generator 126 to generate a file type or file category and a session key generator 128. The session key generator 128 may generate a session key when there are any particular portions in the data file to be sent to selected receiver electronic devices 102a, 102b, 102c, etc. The session key generator 128 may generate the session key by encrypting the random key generated by the random key generator 124 with the private key of the sender electronic device, i.e. the first electronic device 102 and the public key of the receiver electronic devices 102a, 102b, 102c, etc., selected at the first electronic device 102. Further, the session key generator 128 may store the session key in one or more data chunks of the data file. The content encoder 112 may include a mapping generator 130 to provide information regarding order of arrangement of the one or more sub-portions obtained from the selected portions of the data file and a file hash (FHash) generator 132 for encrypting the mapped sub-portions obtained from the selected portions of the data file using a hash value generated by a hash generator 134. The content encoder 112 may include a file link generator 136 to generate a file link of the data file uploaded to a cloud server 140 using a content uploader 138. The encrypted portions of the data file generated using the content encoder 112 may be encoded using the public key of the selected receiver electronic device 102a, 102b, 102c, etc. obtained by the key fetcher 114. The packet generator 116 may generate the one or more encrypted data packets from the encoded portions of the data file and the blockchain network communicator 118 may transfer the one or more encrypted data packets to the blockchain network 108 for access by the receiver electronic devices 102a, 102b, 102c, etc., selected at the first electronic device 102.

According to an embodiment, the first electronic device 102 may be configured to transmit a portion of the data file to the second electronic device 102a through the blockchain network 108. Herein, the user may be requested to select a data file to be shared using the first electronic device 102. In an embodiment, a graphical user interface (GUI) may be presented to the user through a display screen of the first electronic device 102 to select the data file for sharing using the blockchain network 108. In an embodiment, the processor 104 of the first electronic device 102 may be configured to present on the display screen the GUI through which the user may select the data file to be shared from the memory 106 or storage unit of the first electronic device 102. In an embodiment, the GUI of the first electronic device 102 may allow the users to select the data file from a cloud storage or a cloud server. Once the user selects the data file, the GUI may allow the user to provide a user input to protect at least one portion of the data file. The user input detector 110 of the first electronic device 102 may be configured to detect a user input received through the GUI to protect the at least one portion of the data file and at least one data property of the data file. In an embodiment, the GUI on the first electronic device 102 may allow the user to provide the user input in form of a selection of the at least one portion of the data file. In an embodiment, the data property of the data file may be set through the GUI. In an embodiment, the selection of the at least one portion of the data file and setting the data property of the data file may be performed through a plurality of GUIs on the first electronic device 102.

In one embodiment, the data property of the data file set through the GUI on the first electronic device 102 may include a forward or share counter to count a number of times the at least one data file is forwarded or shared in the blockchain network 108, a forward lock to restrict the at least one second electronic device 102a for forwarding the received data file with other electronic devices 102b, 102c, etc., in the blockchain network 108, a share lock to restrict the at least one second electronic device 102a for sharing the at least one received data file with other electronic devices 102b, 102c, etc., in the blockchain network 108, and a spam indicator to indicate infelicitous or irrelevant or unsolicited content of the at least one data file to the at least one second electronic device 102a in the blockchain network 108 and a file linker to link the data file in a file system for space optimization, but are not limited thereto.

Once the at least one portion of the data file and data property of the data file is set, the GUI may allow the users to select the receiver electronic devices 102a, 102b, 102c, etc., connected to the blockchain network 108. The users may utilize the GUI to select one or more receiver electronic devices 102a, 102b, 102c, etc., for sharing the at least one portion of the data file using the blockchain network 108. In an embodiment, the user may select the second electronic device 102a through the GUI on the first electronic device 102. Upon selecting the second electronic device 102a as a receiver, the key fetcher 114 of the first electronic device 102 may extract a public key of the second electronic device 102a from the blockchain network 108 and deliver it to the content encoder 112. The content encoder 112 may receive the public key of the second electronic device 102a and, the GID generator 122 may generate a group ID using a private key (PrivKSendr) of the first electronic device 102 or the sender, and the public key (PubKRecv) of the second electronic device 102a or the receiver. The GID generator 122 may encrypt the public key of the receiver electronic device, i.e. the second electronic device 102a with the private key of the sender i.e. the first electronic device 102.

GID(Group ID)=(PubKRecv)_{PrivKSendr}

A group ID generated using the GID generator 122 may be used to identify the receiver electronic device, i.e. the second electronic device 102a.

In an embodiment, the first electronic device 102 may transmit the data file to a plurality of receivers or receiver electronic devices 102a, 102b and 102c, via the blockchain network 108. Herein, the key fetcher 114 of the first electronic device 102 may extract public keys Pk1, Pk2, Pk3 of the receiver electronic devices 102a, 102b and 102c, respectively, from the blockchain network 108 and deliver them to the content encoder 112. The GID generator 122 then may encrypt the public keys of all the receiver electronic devices 102a, 102b and 102c with the private key of the sender i.e. the first electronic device 102.

GID(Group ID)=(Pk1+Pk2+Pk3)_{PrivKSendr}

The GID generated may be an encrypted key having a combination of public key of all the receiver electronic devices 102a, 102b and 102c encrypted with the private key of the sender or the first electronic device 102. A group ID generated using the GID generator 122 may be used to identify the receiver electronic device, i.e. the second electronic device 102a.

When the user selects one or more portions of the data file to be encrypted, each of the portions may be encrypted using the session key. The session key generated for each sender and receiver(s) combination is unique and may be utilized to encrypt the selected portions of the data file for each receiver(s). In order to generate the session key, the random key generator 124 of the sender or the first electronic device 102 may generate a random key and deliver the random key to the session key generator 128. The session key generated by the session key generator 128 may carry information regarding the number of chunks in the data file and a start and end position of each chunk. Further, the session key may carry information of the encrypted chunks. When the user selects no particular portion in the data file to transmit to a particular receiver or group of receivers, the session key may be not generated by the session key generator 128.

The file type generator or the FType generator 126 of the first electronic device 102 or the sender may generate an FType value corresponding to a file type of the data file. The FType value generated by the FType generator 126 may represent the file type of the data file, such as video, image or text file, but are not limited thereto. When a particular portion or portions of the data file is selected to be encrypted for the selected receiver, i.e. the second electronic device 102a, the FType generator 126 may generate the FType value by combining the file type with that an encrypted session key. The session key may be encrypted using the private key of sender or the first electronic device 102 and the public key of receiver, i.e. the second electronic device 102a. In an embodiment, the session key generated using the session key generator 128 may be a 16 bit encrypted session key which is encrypted using the private key of the sender and public key of the receiver.
FType: Video/Audio/mage . . . +16 bit encrypted
   (SessKRecvr)_{PrivKSendr+PubKRecvr}

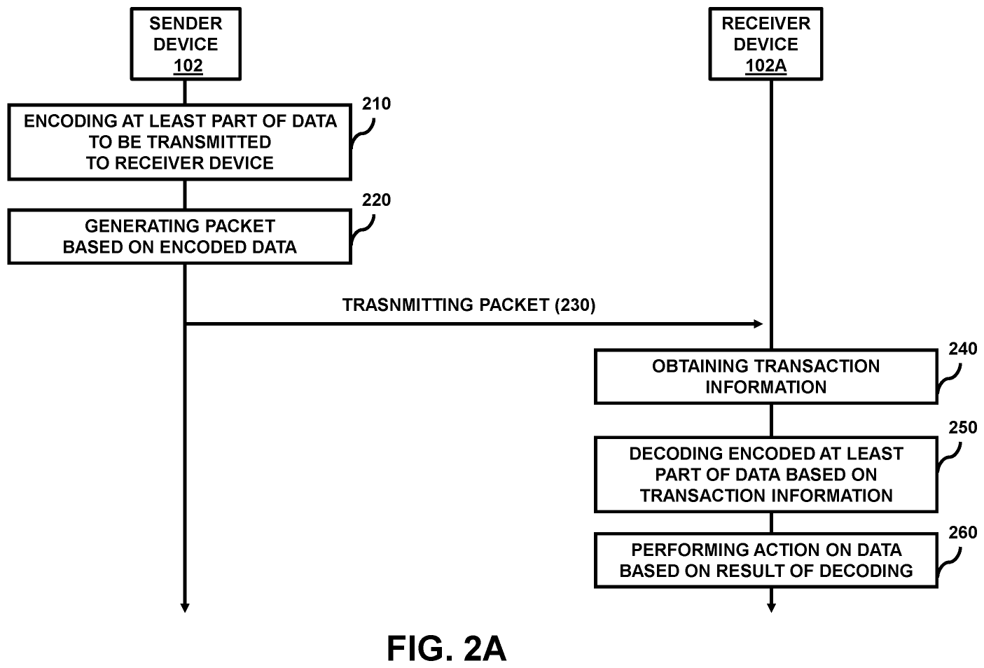

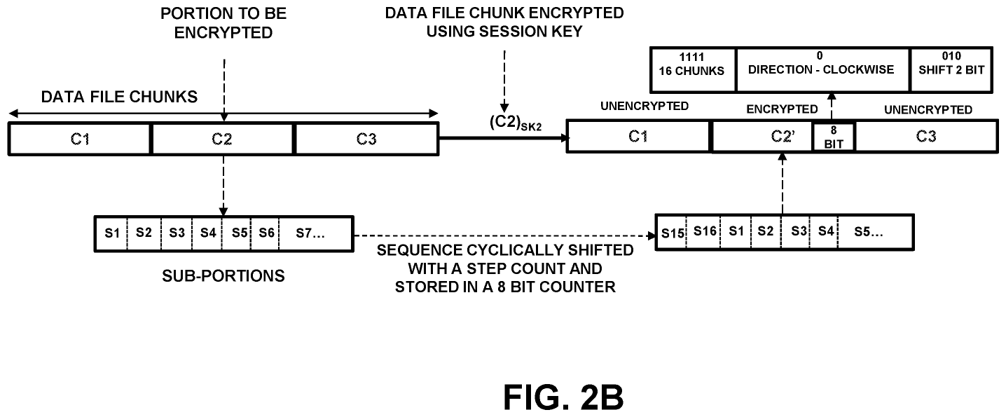

FIG. 2A illustrates a flowchart of a method according to an embodiment of the disclosure.

Referring to FIG. 2A, in operation 210, the first electronic device 102 (e.g., a sender device) may encode at least one portion of data to be transmitted to a receiver device 102a. The sender device 102 and the receiver device 102a may function as nodes of a blockchain network. Encoding of data or encryption of data may be performed by dividing the at least part of data to sub-portions, and changing a sequence of the split sub-portions. The sequence of the sub-portions may be changed randomly, or shifted cyclically. The data may be encoded using a session key. The change of the sequence of the sub-portions and the session key will be explained later.

In operation 220, the sender device 102 may generate a packet based on the encoded data. The encoded data may include the encoded at least part of the data.

In operation 230, the packet generated by the sender device 102 may be transmitted from the sender device 102 to the receiver device 102a.

In operation 240, the receiver device 102a may obtain transaction information. The transaction information may be propagated in a blockchain network when the transaction information is transmitted from the sender device 102 to the receiver device 102a. The transaction information may be propagated to nodes of the blockchain network, and added to blocks stored in the nodes. That is, transaction blocks which are stored in the blockchain network may be updated based on the transaction information. The transaction information is added to blocks and propagated to all nodes so as to prevent unauthorized modification. When a packet is transmitted from the sender device 102 to the receiver device 102a, the transaction information may be transmitted to the receiver device 102a along with the packet, or included in the packet. In an embodiment, the transaction information may include various information. For example, the transaction information may include forward-lock information for indicating whether at least part of data is forward-locked, but is not limited thereto. The transaction information may include spam information for indicating whether data is spam, and link information for indicating a link to data stored in a cloud server, etc., various information included in the transaction information will be explained later.

In operation 250, the receiver device 102a may decode the encoded at least part of data based on the transaction information. The decoding of data may be performed by changing the sequence of the sub-portions. The sequence of the sub-portions may be changed to their original sequence before the data is encoded. The data may be decoded using a session key. The change of the sequence of the sub-portions and the session key will be explained later.

In operation 260, the receiver device 102a may perform an action on the data based on a result of the decoding. For example, the decoded part may be displayed as being unimpaired for a user. When the decoding is failed, the portion may be blurred, pixelated, or removed on the receiver device, or whole data may be not displayed or loading of the data may be not available at the receiver device 102a.

FIG. 2B illustrates a block diagram for explaining operations of a file hash generator to generate a file hash corresponding to a data file, according to an embodiment of the disclosure.

Referring to FIG. 2B, the file hash generator or the FHash generator 132 of the first electronic device 102 or the sender may carry an original data file to be transmitted via the blockchain network 108. When at least one portion of the data file is selected to be encrypted for a particular receiver, i.e. the second electronic device 102a, the portions of the data file may be divided into sub-portions and shuffled. The FHash or the file hash generated using the file hash generator 132 may include a mapping of the shuffled sub-portions. The file hash generator 132 maps the sub-portions of the data file using a hash value generated by the hash generator 134. In an embodiment, the FHash or the file hash generated using the file hash generator 132 may contain an 8-bit content mapping, in which the first 4-bit may be used to define the number of sub-portions into which the encrypted portion of the data file is divided into, fifth bit may be used to define shifting direction of the shuffled sub-portions and the last 3-bits may be used to define the number of operations in which the sub-portions are shifted. For example, the 8-bit content mapping may be used to define the maximum of 16 sub-portions with the first 4-bit, but is not limited thereto. The fifth bit in the 8-bit content mapping may represent a clockwise shifting (to a right direction) when its bit value is set to zero, and represent a counter-clockwise shifting (to a left direction) if the bit value is set to one, but is not limited thereto. When a rightmost sub-portion is shifted clockwisely (to a right direction) once, the sub-portion is moved to a leftmost location by the shifting. When a leftmost sub-portion is shifted counter-clockwisely (to a left direction) once, the sub-portion is moved to a rightmost location by the shifting. When there are more than 16 sub portions of the data file, a higher bit of mapping may be used to define the shuffled sub-portions in the encrypted data file.

In an embodiment, the processor 104 of the first electronic device 102 or the sender may be configured to set a flag indicating an enable or disable status of the at least one data property of the data file. The data property of the data file may be set by users sending or receiving the data file through a GUI on the sender or receiver electronic devices. In an embodiment, the processor 104 of the first electronic device 102 or the sender may be configured to set a 3-bit flag to indicate the data property, such as forward tracking, spam marking and space management, based on the data property of the data file set by the user through the GUI on the first electronic device 102. The value of the 3-bit flag may be used to define a status of activation of various features. For example, a first bit may be used to define whether a forward-locking is enabled. When the first bit is set to ‘1’, the receiver or the second electronic device 102a may be prevented from sending the data file to anyone. The second bit of the 3-bit flag may be used for spam management. When the second bit is set to ‘1’, that the sender or the first electronic device 102 or the receiver, i.e. the second electronic device 102a forwarding the data file has found something infelicitous in the data file and mark the data file as a spam. The third bit of the 3-bit flag may be used for space management. When the third bit is set to ‘1’, which indicates that the sender or the first electronic device 102 has uploaded the data file on the cloud server 140 or a secondary storage to send the data file to the receiver or the second electronic device 102a. The following table, Table 1, lists the flag values and corresponding representations in the data file.

TABLE 1

| Forward | Spam | Space | |
|---|---|---|---|
| Track | Management | Management | Flag |
| 0 | 0 | 0 | No encrypted portion |
| 0 | 1 | 0 | No encrypted portion \| |
| | | | Spam marked |
| 0 | 0 | 1 | No encrypted portion \| |
| | | | Space managed |
| 1 | 0 | 0 | Encrypted forward locked portion |

Further, if the sender or the first electronic device 102 uploads the data file on the cloud server 140 using the content uploader 138, then the file link generator 136 may generate a link to the stored data file in the cloud server 140 and add the link to the chunks of the data file prior to sending the data file.

The encrypted portions of the data file may be combined with a sender ID of the sender electronic device i.e. the first electronic device 102. The sender ID may be any unique ID such as a machine ID, a mobile number, user ID or any ID of the sender or the first electronic device 102. The encrypted portions of the data file may be sent to the packet generator 116 to generate one or more encrypted data packets. The encrypted data packet may include a group identifier (GID) of the first electronic device 102 and the at least one second electronic device 102a, a unique identifier (SID) of the first electronic device 102, a file type (FType) information of the data file, a hash value (FHash) of the data file including the data file and indicating the at least one portion of the data file, a flag (Flag) indicating an enable or disable status of the at least one data property of the data file and optional file link (File Link) if the data file is uploaded in the cloud server 140, but is not limited thereto.

TABLE 2

| | | | | | |
|---|---|---|---|---|---|
| GID | SID | FType | FHash | Flag | File Link |

In an embodiment, the packet generator 116 may generate the one or more encrypted data packets from the encrypted data file, and the blockchain network communicator 118 may transfer the one or more encrypted data packets to the blockchain network 108 for allowing the receiver electronic device, i.e. the second electronic device 102a to access the data file. Once the encrypted data packets are transmitted to the blockchain network 108, each block in the blockchain network 108 may be updated based on the transaction. The blockchain network 108 may be configured to request consent of the first electronic device 102 for the receiver electronic device, i.e. the second electronic device 102a to forward the data packet, when the data packet includes forward locked content.

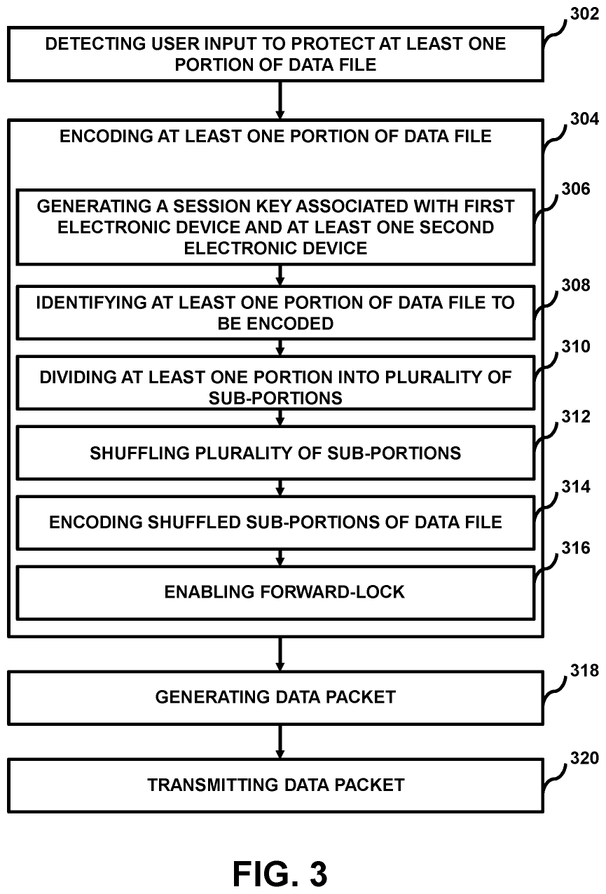

FIG. 3 illustrates a flow chart for explaining a method of sharing a protected data file using a blockchain network, according to an embodiment of the disclosure.

According to the method, a user input to protect at least one portion of the data file and at least one data property of the data file may be detected at the first electronic device 102 in operation 302, Once the user input to protect at least one portion of the data file and at least one data property of the data file is detected, the first electronic device 102 may encode the at least one portion of the data file and the at least one data property of the data file in operation 304. Referring to FIG. 3, operation 304 in which the at least one portion of the data file and the at least one data property of the data file are encoded by the first electronic device 102 may include operations 306, 308, 310, 312, 314, and 316 as illustrated in FIG. 3. Operations are illustrated in FIG. 3 as being performed according to a certain sequence, but it should be understood the disclosure is not limited the described sequence.

In operation 306, a session key associated with the first electronic device (102) and the at least one second electronic device (102a, 102b, or 102c) may be generated by the first electronic device 102. In operation 308, at least one portion of a data file to be encoded may be identified based on a user input. In operation 310, the at least one portion of the data file may be divided into a plurality of sub-portions. In operation 312, the sub-portions may be shuffled. In operation 314, the shuffled sub-portions of the data file may be encoded using a session key. Once the encoded data file is generated, the at least one data property of the data file may be enabled based on the user input at the first electronic device 102 in operation 316. Operation 316 may be performed prior to operation 302. The portion of the data file may be encoded by a user enabling a forward-lock and selecting the portion to be locked.

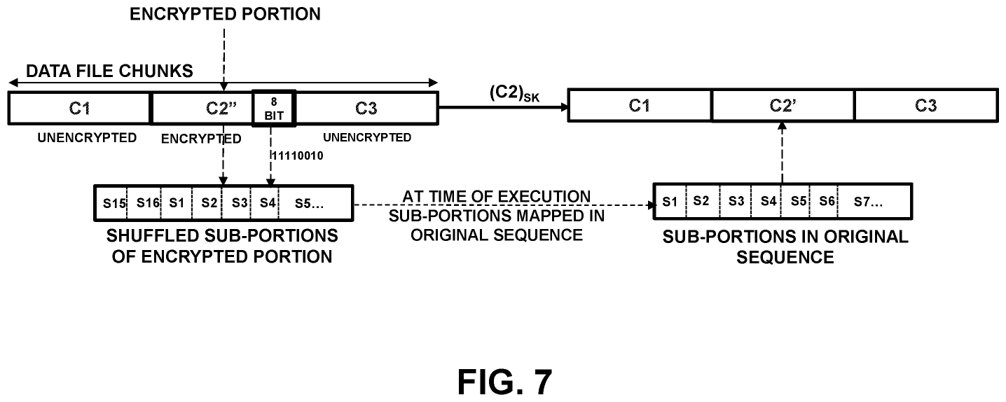

The shuffling of the sub-portions of the data file will be explained later by referring to FIG. 7.

In operation 318, the first electronic device 102 may generate the at least one data packet including the at least one encoded portion of the data file and the at least one encoded data property of the encoded data file. Once the at least one data packet is generated, the first electronic device 102 may transmit the at least one data packet to the at least one second, third or fourth electronic device 102a, 102b, 102c, etc. in the blockchain network 108 in operation 320. The at least one data property of the data file may include a forward or share counter to count a number of times the data file is forwarded or shared in the blockchain network 108, a forward lock to restrict the at least one second electronic device 102a for forwarding the data file with other electronic devices 102b, 102c etc., in the blockchain network 108, a share lock to restrict the at least one second electronic device 102a for sharing the data file with other electronic devices 102b or 102c in the blockchain network, and a spam indicator to indicate infelicitous or irrelevant or unsolicited content of the data file to the at least one second, third or fourth electronic device 102a, 102b or 102c in the blockchain network 108 and a file linker to link the data file in a file system for space optimization, but is not limited thereto. Further, the at least one data packet may include the group identifier of the first electronic device 102 and the at least one second, third or fourth electronic device 102a, 102b or 102c, the unique identifier of the first electronic device 102, the file type information of the data file, the hash value of the data file indicating the at least one portion of the data file, flag indicating an enable or disable status of the at least one data property of the data file.

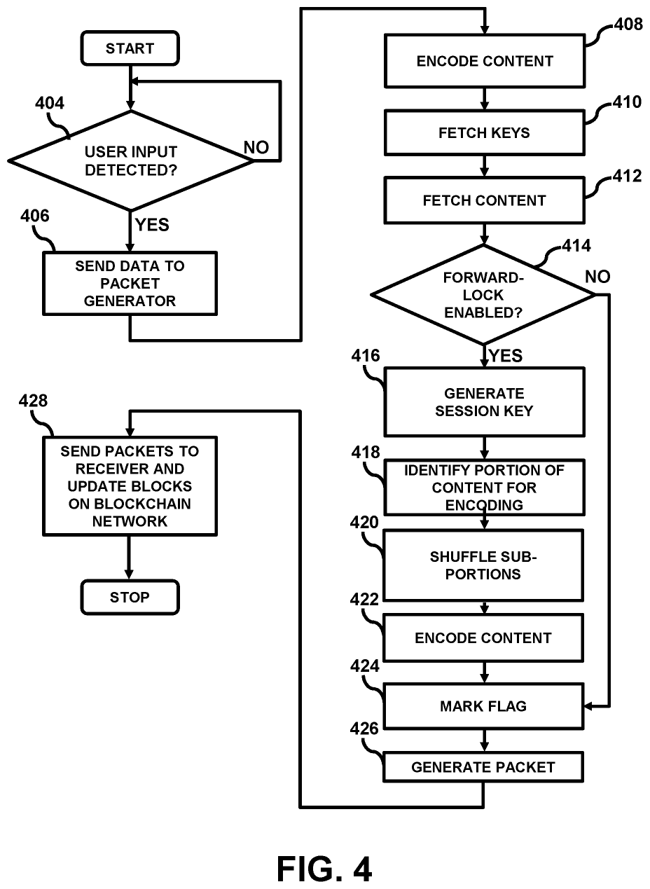

FIG. 4 illustrates a detailed flow chart for explaining a method of sharing a protected data file using a blockchain network, according to an embodiment of the disclosure.

The method may be started by selecting a desired data file to be shared by a sender or first electronic device 102. Referring to FIG. 4, in operation 404, the user input detector 110 of the sender or first electronic device 102 may detect whether a user input to protect the at least one portion of the data file and the at least one data property of the data file at the first electronic device 102 is received from the user. In operation 406, the first electronic device 102 may deliver the data file to the packet generator 116 for generating data packets to be sent through the blockchain network 108. Upon detecting the user input to protect the at least one portion of the data file, the data file may be delivered to the content encoder 112 in operation 408. In operation 410, the key fetcher 114 associated with the sender or the first electronic device 102 may fetch a private key of the sender or the first electronic device 102 and public key(s) of the receiver electronic device(s) 102a, 102b and 102c. The fetching of keys may be performed by searching the blockchain network 108, but is not limited thereto. In operation 412, the content encoder 112 associated with the sender or the first electronic device 102 may extract contents of the data file. In operation 414, the sender or the first electronic device 102 may determine whether forward lock is enabled by its user. When a forward-lock is enabled for a selected portion of the data file, the session key generator 128 associated with the sender or the first electronic device 102 may generate a session key for encrypting the at least one portion of the data file to be protected, in operation 416. The session key generator 128 may utilize a random key generated by the random key generator 124, and the random key may be encoded with a public key of the receiver device 102a, 102b or 102c.

The FType generator 126 may encrypt a file type of the data file with the session key encrypted using the private key of the sender or the first electronic device 102 and the public key of the receiver device 102a, 102b or 102c. In operation 418, the at least one portion of the data file for encoding may be identified based on the user input at the sender or the first electronic device 102. The FHash generator 132 may divide the data file into chunks and the at least one portion of the data file for encryption may be divided into a plurality of sub-portions. In operation 420, the FHash generator 132 may shuffle the sub-portions, generate a mapping of the shuffled sub-portions using the mapping generator 130, and store the mapping with the chunks of the data file. In operation 422, the encrypted portions of the data file may be encoded with the session key. In operation 424, a flag value may be set for the encrypted portions of the data file based on the user input received at the sender or the first electronic device 102. In operation 426, the encrypted data file with the encoded portions may be used for making data packets for transmission.

When a forward-lock is not enabled at the first electronic device 102 in operation 414, the contents of the data file fetched in operation 412 may have a flag set in operation 424, then used to generate a data packet for transmission in operation 426. The data packet generator 116 may generate the data packets from the encrypted data file, the encrypted data packets may be sent to the receiver electronic device(s) 102a, 102b and 102c in operation 428. Accordingly, the transaction details may be updated in the blockchain network 108. The sharing of the data file may be performed through the above operations, but is not limited thereto.

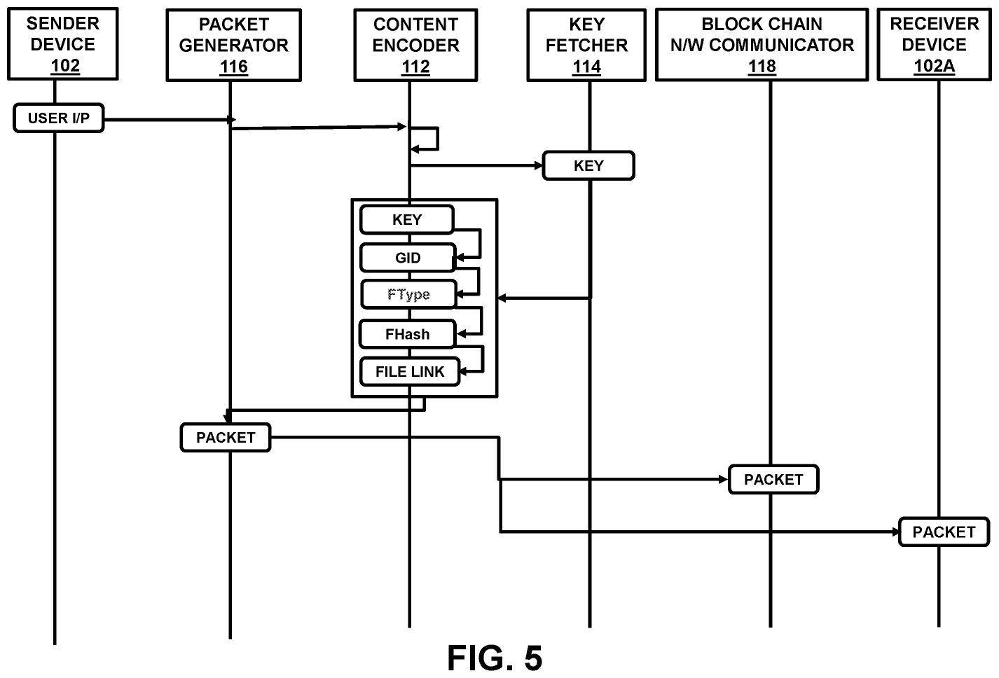

FIG. 5 illustrates a timing diagram for explaining a sequence of operations for sharing a protected data file using a blockchain network, according to an embodiment of the disclosure.

Referring to FIG. 5, a user may select a desired data file to be shared at a first electronic device 102 and provides a user input to protect a at least one portion of the data file. The first electronic device 102 may deliver the data file to the packet generator 116 for generating data packets to be sent through the blockchain network 108. Upon detecting the user input to protect the at least one portion of the data file, the data file may be delivered to the content encoder 112. The key fetcher 114 associated with the sender or the first electronic device 102 may fetch a private key of the sender or the first electronic device 102 and public key(s) of the receiver electronic device(s) 102a, 102b and 102c, as in block or operation 410 from the blockchain network 108. Further, the content encoder 112 may generate the encrypted data file with the at least one encoded portion. The encrypted data file may include the at least one encoded portion including a sender ID, a group ID including a public key of the receiver electronic device(s) 102a, 102b and 102c encrypted using a private key of the sender or the first electronic device 102, FType encrypted with session key of the receiver electronic device(s) 102a, 102b and 102c, the FHash corresponding to the encrypted data file with the mapping of the sub-portions in the data file, and a file link if the data file is stored in the cloud server 140, but is not limited thereto. The encrypted data file may be delivered to the packet generator 116 to generate encrypted data packets and send them to the receiver electronic device(s) 102a, 102b and 102c via the blockchain network 108 by using the blockchain network communicator 118. Upon sending the encrypted data packets to the blockchain network 108, the sender or the first electronic device 102 may generate a blockchain transaction batch and update blocks in the blockchain network 108.

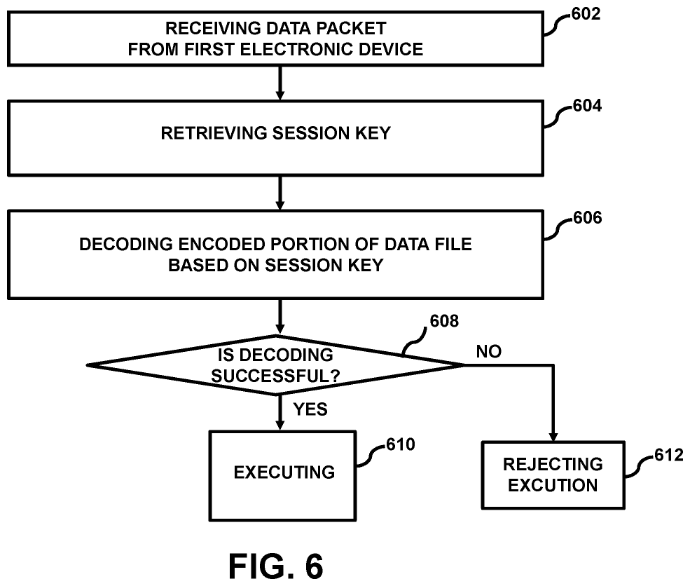

FIG. 6 illustrates a flow chart for explaining operations at the receiver electronic device to retrieve the at least one portion of the data file, according to an embodiment of the disclosure.

Referring to FIG. 6, in operation 602, the at least one data packet may be received by the at least one receiver electronic device 102a, 102b or 102c, from the first electronic device 102 through the blockchain network 108.

In operation 604, the at least one receiver electronic device 102a, 102b or 102c may retrieve a session key associated with the first electronic device 102 and the at least one second electronic device 102a, 102b or 102c.

In operation 606, the at least one second electronic device 102a, 102b or 102c may decode the at least one encoded portion of the encoded data file by shuffling the sub-portions in the data file based on the session key.

In operation 608, the at least one second electronic device 102a, 102b or 102c may determine whether the decoding of the at least one encoded portion of the encoded data file is successful.

In operation 610, the at least one encoded portion of the encoded data file may be executed to retrieve the at least one portion of the data file in response to determining that decoding of the at least one encoded portion of the encoded data file is successful.

In operation 612, the at least one second electronic device 102a, 102b or 102c may reject execution of the at least one encoded portion of the encoded data file in response to determining that the decoding of the at least one encoded portion of the encoded data file is not successful.

Once the encoded portion of the data file is decoded, the at least one second electronic device 102a, 102b or 102c may detect presence of the at least one data property of the data file, and if the at least one data property of the data file is present, a status of the at least one data property of the data file in the at least one data packet may be determined. The at least one second electronic device 102a, 102b or 102c may perform one or more actions corresponding to the at least one data property of the data file in response to detecting the status of the at least one data property as enabled, or rejects the action corresponding to the at least one data property of the data file in response to detecting that the status of the at least one data property as disabled. In an embodiment, the action may include one of a forwarding action and a sharing action on the data file. The at least one second electronic device 102a, 102b or 102c may be configured to increment a forward or share counter in response to performing forwarding or sharing action on the data file. Further, after receiving the data file, the status of the data file such as a forward-lock or spam level may be presented through a GUI of the at least one second electronic device 102a, 102b or 102c.

FIG. 7 illustrates a block diagram for explaining operation of a receiver electronic device to retrieve at least one portion of a data file, according to an embodiment of the disclosure.

Referring to FIG. 7, the receiver electronic device 102a, 102b or 102c may receive encrypted data packets of encrypted data file from the blockchain network 108. The encrypted data packets received at the receiver electronic device 102a, 102b or 102c may include following elements as in Table 3.

TABLE 3

| | | | | | |
|---|---|---|---|---|---|
| GID | SID | FType | FHash | Flag | File Link |

Upon receiving the encrypted data packets, the receiver electronic device 102a, 102b or 102c may decrypt the GID using its private keys, respectively. The public key in the GID may be matched with the public key of the of the receiver electronic devices 102a, 102b or 102c. If a match is found, the receiver electronic device 102a, 102b or 102c may decode the encrypted data packet, respectively. If there is no match found between the public key of the receiver electronic devices 102a, 102b or 102c and the public key in the GID, the receiver electronic devices 102a, 102b or 102c may be configured to reject the encrypted data packet. Further, the receiver electronic device 102a, 102b or 102c may check the sender ID or SID. Further, the receiver electronic device 102a, 102b or 102c may check a flag status to identify data packet characteristics, such as presence of forward-locked encrypted content in the data packet, whether the data packet is spam content, and presence of file link in the data packet.

Based on the flag status, the session key and the file characteristics may be decrypted from the FType at the receiver electronic device 102a, 102b or 102c. The file characteristics may indicate the type of file such as video, text or image, but is not limited thereto. The session key decryption may be performed in correspondence to the process of using public key of sender and private key of receiver. If some portions or sections of the data file are encrypted, which are identified from the session key, then section information may be extracted using the receiver electronic device 102a, 102b or 102c. Based on the section information extracted from FType, the data file corresponding to the FHash may be divided into chunks. If any encrypted portion is present in any of the chunks, the encrypted portion may be decrypted using a session key extracted from the FType. Further, the sub-portions obtained may be shuffled based on the mapping of the shuffled sub-portions retrieved from the chunks of the data file. For example, the last 8-bit mapping information of the chunk is extracted, and the number of sub chunks may be derived from the first 4-bits. When there are 16 sub-portions, the first 4-bits may be 1111. Further, in the 8-bit mapping information, the 5th-bit may indicate a direction in which the sub-portions are shifted. The last 3-bits in the 8-bit mapping information may indicate the number of shifting of the sub-portions. Thus the sub-portions may be shifted by the indicated number and direction to generate the at least one portion of the data file at run time.

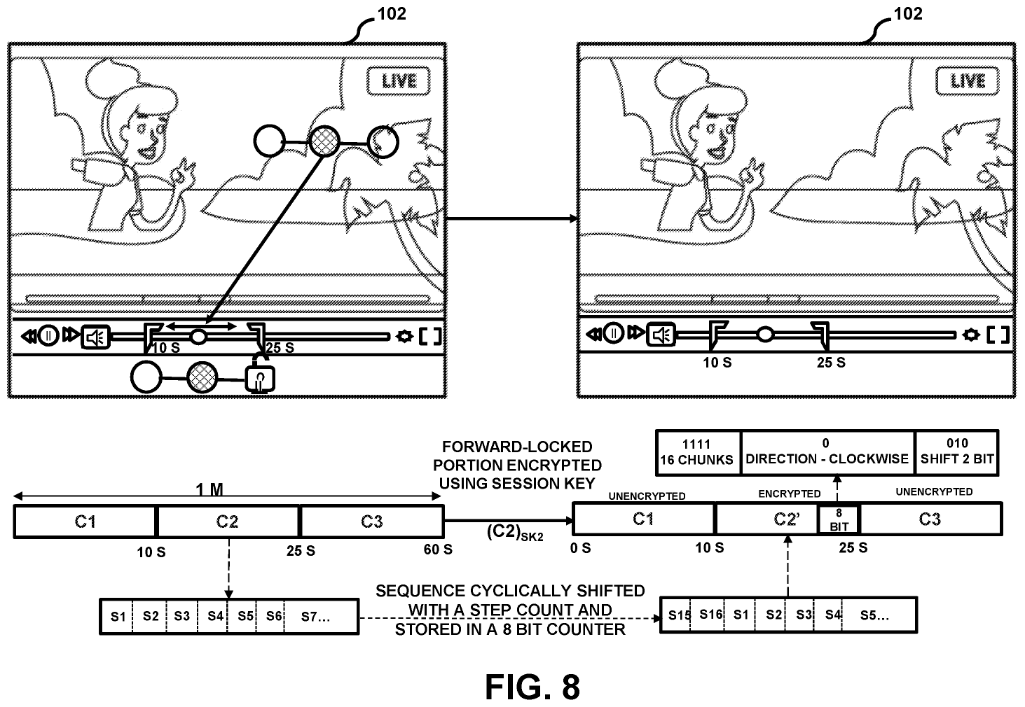

FIG. 8 illustrates an example use case of selective sharing of one or more portions of a video file using a blockchain network, according to an embodiment of the disclosure.

Referring to FIG. 8, the video file with a forward locked content may be sent by a sender to a receiver through the blockchain network 108. The sender may select a video file of 60 seconds duration using a first electronic device 102. Further, the sender may set a data property of the video file by selecting a portion of the video file from 10 seconds to 25 seconds to forward-lock the portion, through the GUI of the first electronic device 102. Once the at least one portion of the video file and the data property of the selected portion of the video file is set, the GUI may allow a user (the sender) to select receiver electronic devices 102a, 102b, 102c, etc., connected to the blockchain network 108. The GUI may be displayed for the user to select one or more receiver electronic devices 102a, 102b, 102c, etc., for sharing the at least one portion of the video file using the blockchain network 108.

In an embodiment, the user may select a second electronic device 102a and a third electronic device 102b through the GUI on the first electronic device 102. The first electronic device 102 may set a group ID by encrypting public keys of second and third electronic devices 102a, 102b with a private key of the first electronic device 102. A sender ID may be selected, which may be a device ID or user ID or a user name of the sender. The first electronic device 102 may generate a file type or FType as a video file category. The first electronic device 102 may generate a session key for receiver electronic devices 102a, 102b when a forward-lock is applied to a portion in the video file based on a user input through the GUI. The session key may be encrypted using the private key of the sender or the first electronic device 102 and the public keys of the receiver electronic devices 102a, 102b. The session key may carry information regarding the number of chunks in the video file and the start and end position of each of the chunks. Further, the session key may carry information of the encrypted chunks. The first electronic device 102 or the sender may set a 3-bit flag. The first bit of the flag, representing the presence of forward locked content, may be set as ‘1’ as the video file contains an encrypted forward-locked portion from 10 s to 25 s. In order to generate the file hash or FHash, the video file may be divided into three chunks, where chunk 1 has duration from 0 s to 10 s, chunk 2 has duration from 10 s to 25 s, and chunk 3 has duration from 25 s to 60 s. The chunk 1 and chunk 3 may be not encrypted because there is no forward-locked portion therein. Chunk 2 may include a forward-locked portion and the first electronic device 102 may perform encryption of the forward-locked portion.

In an embodiment, chunk 2 may be divided into 16 sub-portions, and each sub-portion may be shifted in clockwise direction twice. An 8-bit register may indicate the direction and number of shifting of the sub-portions. The first 4-bits may indicate the number of sub-portions, 5th bit may indicate the direction of shifting, i.e. 0 for clockwise shifting and 1 for counter-clockwise shifting, and the last 3-bits may represent the number of shifting. For example, last 3-bits of 010 indicates each sub-portion is shifted in a clockwise direction twice. The shuffled chunks may be encrypted using the session key and data packets may be generated, transferred and recorded in the blockchain network 108 by the sender or the first electronic device 102. The transaction record in the blockchain network 108 may be used to find an originator to request the originator for consent of forwarding, when the video file has a forward locked portion and the receiver wants to forward the video file to another user.

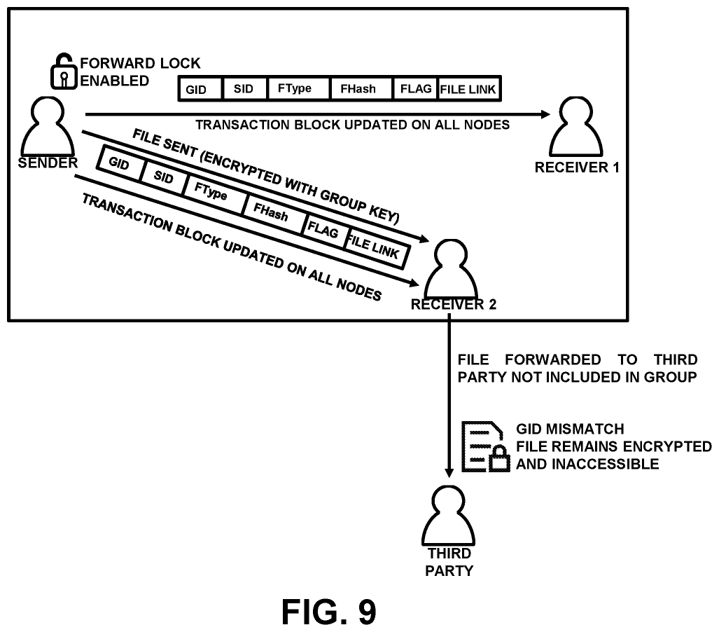

FIG. 9 illustrates an example use case of sharing a data file with at least one forward locked portion from a first electronic device to a user group having receiver electronic devices using a blockchain network, according to an embodiment of the disclosure.

The at least one forward-locked portion in the data file may be encrypted with a session key. The receiver electronic devices 102a and 102b may receive the data file with the at least one forward-locked portion from the blockchain network 108. The receiver electronic device 102a and 102b may be allowed to decrypt the at least one forward-locked portion when public keys of the receiver electronic devices 102a and 102b matches that in a GID associated with the data file received from the blockchain network 108. When any of the receiver electronic devices 102a or 102b tries to forward the data file with the at least one forward locked portion to a third party or the third party electronic device 102c, the third party or the third party electronic device 102c fails to find a matched public key in the GID associated with the data file, and the data file including the at least one forward locked portion remains inaccessible to the third party or the third party electronic device 102c.

In an example scenario, if the receiver or the receiver electronic device 102a or 102b wants to forward the data file having the at least one forward locked portion to the third party or the third party electronic device 102c, the receiver or the receiver electronic device 102a or 102b may be required to seek consent from the sender or the first electronic device 102 through the blockchain network 108. When the third party or the third party electronic device 102c accesses the data file with the at least one forward locked portion received from the receiver electronic device 102a or 102b via the blockchain network 108, it may be indicated on the third party or the third party electronic device 102c that the data file is locked and consent from the originator sender or the first electronic device 102 is required to access the content in the locked data file. In an embodiment, the receiver or the receiver electronic device 102a or 102b may be required to send a forward consent request to the sender or the first electronic device 102. Based on the forward consent request received from the receiver or the receiver electronic device 102a or 102b, the sender or the first electronic device 102 may generate new data packets with new GID and session key for the at least one forward locked portion to send them via the blockchain network 108. The session key of the new data packets may be encrypted with a private key of the sender or the first electronic device 102 and a public key of the third party or the third party electronic device 102c. In an embodiment, the sender or the first electronic device 102 may share its forward consent, which is for sharing the data file to the third party or the third party electronic device 102c from the receiver or the receiver electronic device 102a or 102b, to the respective receiver or the receiver electronic device 102a or 102b via the blockchain network 108. Based on the forward consent received from the sender or the first electronic device 102, the receiver electronic device 102a or 102b is allowed to forward the data file to the third party or the third party electronic device 102c. All the transactions between the sender or the first electronic device 102, the receiver electronic device 102a or 102b are recorded in the blockchain network 108 and the third party or the third party electronic device 102c can access the data file if the forward consent from the sender or the first electronic device 102 is registered in the blockchain network 108.

According to an embodiment, the receiver, i.e. the receiver electronic device 102a or 102b may receive the data file having the at least one forward locked portion from the sender or the first electronic device 102 via the blockchain network 108. Upon receiving the data file having the at least one forward locked portion at the receiver or the receiver electronic devices 102a or 102b, the data file may be decrypted on runtime during the execution of the data file, and the receiver electronic device 102a or 102b is allowed to access the at least one forward locked portion in the data file when the public key of the receiver electronic devices 102a or 102b matches with the encrypted session key associated with the received data file. The decryption of the at least one forward locked portion in the data file during runtime may prevent the receiver electronic devices 102a or 102b from saving or storing the data file, or forwarding the data file to the third party or the third party electronic device 102c. In an embodiment, when the receiver or the receiver electronic devices 102a or 102b modifies at least one portion of data file which is not modification-locked, and forwards the modified data file to the third party or the third party electronic device 102c with a forward consent from the sender or the first electronic device 102, the third party or the third party electronic device 102c receiving the data file may be only able to access the data file of the sender or the first electronic device 102 except the portion modified by the receiver or the receiver electronic devices 102a or 102b.

Referring to FIG. 9, if the receiver or the receiver electronic device 102a or 102b wants to modify at least one portion in the data file received from the sender or the first electronic device 102 and forward the modified data file to the third party or the electronic device 102c, the receiver or the receiver electronic device 102a or 102b may be required to seek consent for modification and forward from the sender or the first electronic device 102 through the blockchain network 108. In an embodiment, the receiver or the receiver electronic device 102a or 102b may be required to send a request to modify the at least one portion in the data file along with the forward consent request to the sender or the first electronic device 102 to first modify the at least one portion in the data file and forward the modified data file to the third party or the electronic device 102c via the blockchain network 108. Based on the request received from the receiver or the receiver electronic device 102a or 102b, the sender or the first electronic device 102 may generate new data packets with the at least one modified portion in the data file along with new GID and session key for the at least one modified portion and sends them via the blockchain network 108. The session key of the new data packets may be encrypted with a private key of the sender or the first electronic device 102 and a public key of the third party or the third party electronic device 102c. The sender or the first electronic device 102 can share the forward consent, which is for sharing the data file with the at least one modified portion to the third party or the third party electronic device 102c from the receiver or the receiver electronic device 102a or 102b, to the respective receiver or the receiver electronic device 102a or 102b via the blockchain network 108. Based on the forward consent received from the sender or the first electronic device 102, the receiver electronic device 102a or 102b may be allowed to forward the data file with the at least one modified portion to the third party or the third party electronic device 102c. In an embodiment, when the third party or the third party electronic device 102c accesses the data file with the at least one forward locked portion received from the receiver electronic device 102a or 102b via the blockchain network 108, it may be indicated on the third party or the third party electronic device 102c that the data file is locked and consent from the originator sender or the first electronic device 102 is required to access the content in the locked data file. The third party or the third party electronic device 102c can access the data file with the at least one modified portion if the forward consent from the sender or the first electronic device 102 is registered in the blockchain network 108.

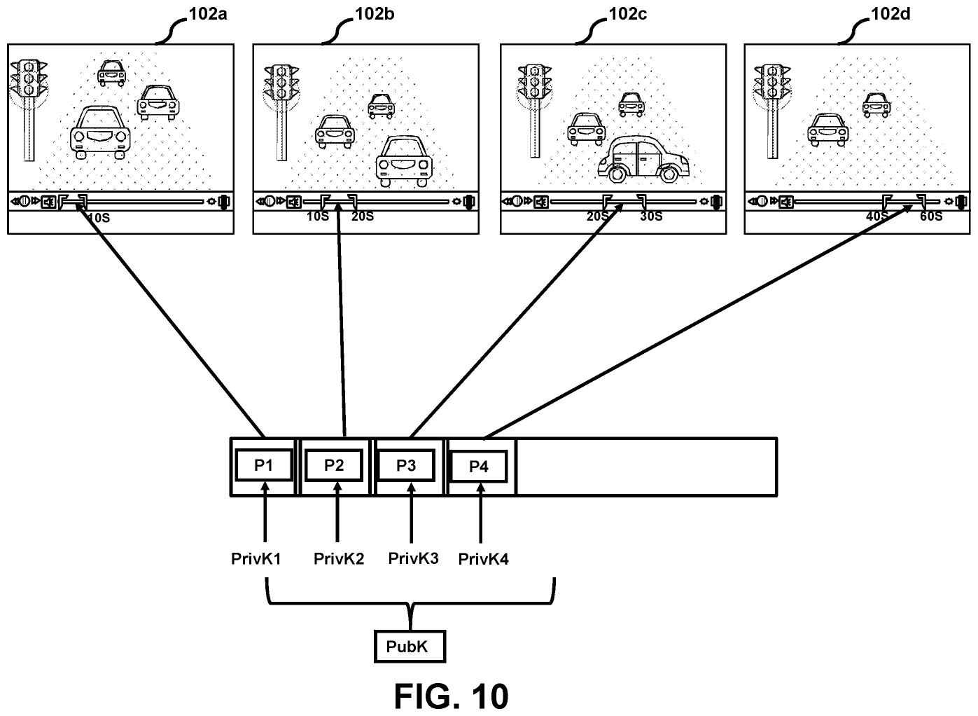

FIG. 10 illustrates an example use case of selectively sharing one or more portions of a traffic violation video file to a plurality of users or receiver electronic devices using a blockchain network, according to an embodiment of the disclosure.

Referring to FIG. 10, a plurality of portions P1, P2, P3, and P4 of a video file may be encrypted for different users or receiver electronic devices 102a, 102b, 102c, and 102d, and a single video file containing all the portions P1, P2, P3, and P4 may be shared among the users through the blockchain network 108. The sender electronic device 102 may encrypt each portion intended for each users using a private key of the sender and each public key of each receiver. The video file with the encrypted plurality of portions P1, P2, P3, and P4 may be transmitted via the blockchain network 108. The encrypted portion P1, P2, P3, or P4 may only be decrypted by the receiver electronic device 102a, 102b, 102c, or 102d, respectively, with its private key that matches with that in the session key in the encrypted portion.

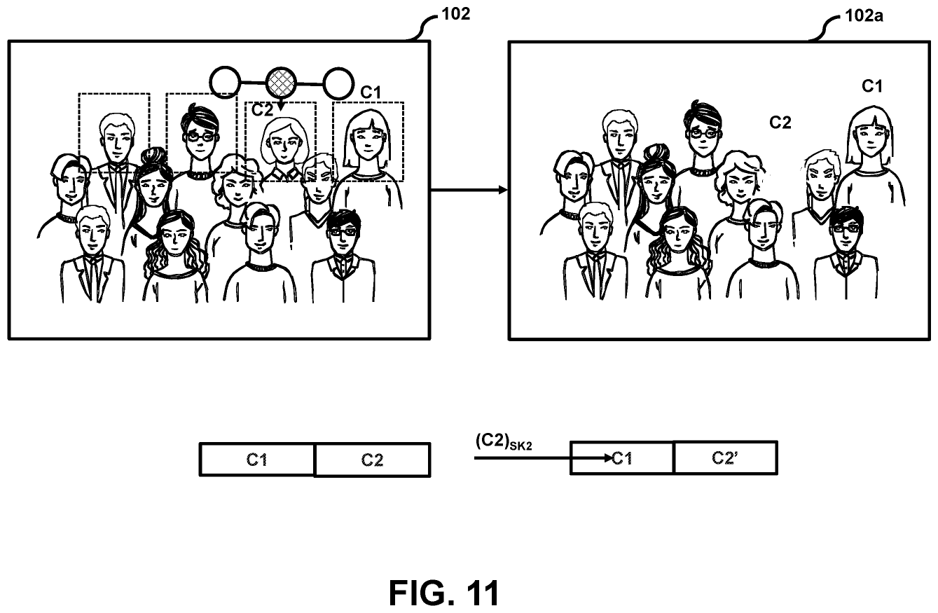

FIG. 11 illustrates an example use case of selectively sharing one or more portions of an image to a plurality of users or receiver electronic devices using a blockchain network, according to an embodiment of the disclosure.

Referring to FIG. 11, a GUI of the sender or the first electronic device may allow a user to set a forward lock on one or more parts of the image, such as an individual face in the image. Based on the forward-lock on the image, the first electronic device 102 may convert the image into pixel chunks. The pixel chunks corresponding to the forward locked portions in the image may be encrypted using a session key, and the image packets with the encrypted pixel chunks may be sent via the blockchain network 108. Only a receiver electronic device accessible to a matched session key is able to decode the encrypted pixel chunks and display an unimpaired image. A part corresponding to the encrypted pixel chunks may be blurred, pixelated, or removed for unauthorized users, or whole data may be not displayed or loading of the data may be not available by the unauthorized users.

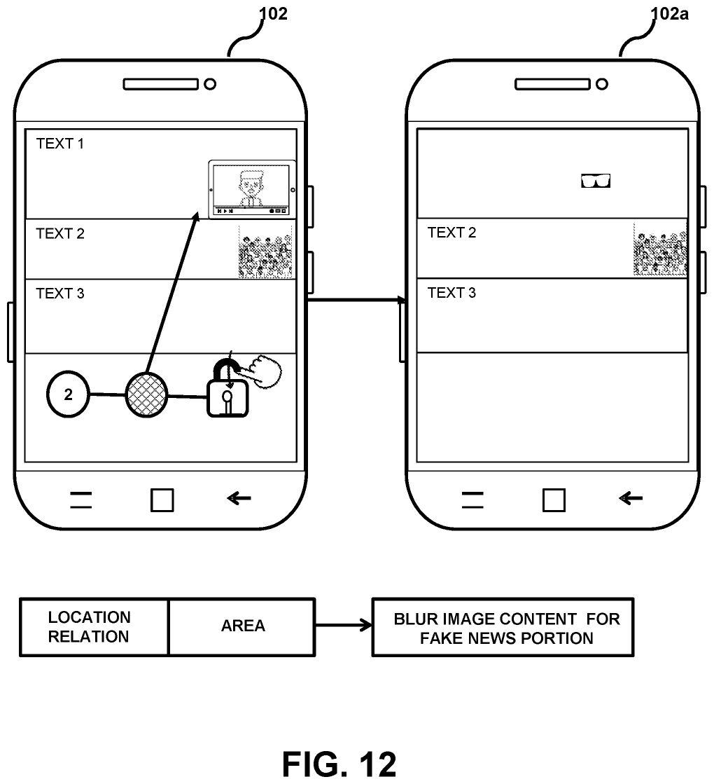

FIG. 12 illustrates an example use case of selectively sharing one or more portions of a text page to a plurality of users or receiver electronic devices using a blockchain network, according to an embodiment of the disclosure.

Referring to FIG. 12, a GUI of the sender or the first electronic device may allow a user to set a forward lock on one or more parts of a page, such as particular article or sections in the page. Based on the forward lock on the page, the first electronic device 102 may covert the page into chunks. The chunks corresponding to the forward locked portions in the page may be encrypted using a session key, and packets with the encrypted pixel chunks may be sent via the blockchain network 108. Only a receiver electronic device accessible to a matched session key is able to decode the encrypted chunks and display an unimpaired page. A part corresponding to the encrypted chunks may be blurred, pixelated, or removed for unauthorized users, or whole data may be not displayed or loading of the data may be not available by the unauthorized users.

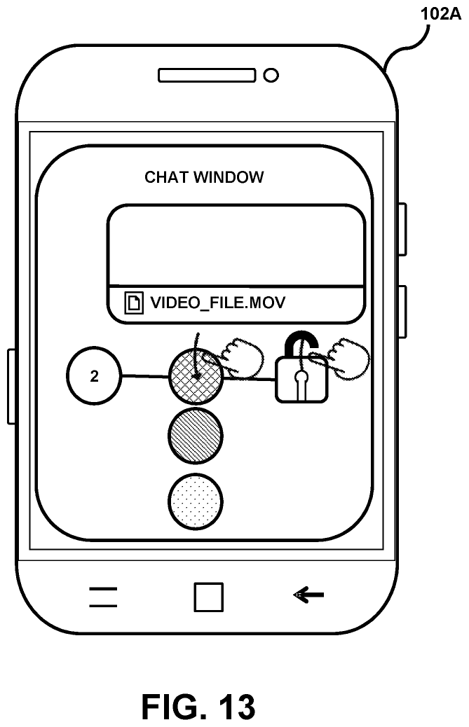

FIG. 13 illustrates an example use case of spam management in a shared data file at a receiver electronic devices using a blockchain network, according to an embodiment of the disclosure.

Referring to FIG. 13, a GUI of the receiver electronic devices 102a, 102b, 102c etc., may allow a user to set a spam flag if the receiver finds infelicitous content in the received data file. In an embodiment, the GUI of the receiver electronic device 102a may include a spam level indicator of the received data file, such as low spam probability, medium spam probability and high spam probability. Once the spam flag is set, all the transaction blocks in the blockchain network may be updated. Whenever the data file is forwarded, the spam level indicator may be presented via the GUI of the receiver electronic devices 102a, 102b, or 102c.

In an embodiment, following operations may be performed when infelicitous content is found in a received data file. When a receiver electronic device 102a finds infelicitous content in the data file, the receiver or user of the receiver electronic device 102a may mark the second bit in flag as ‘1’. An updated data packet containing GID, SID and spam-marked flag may be sent to blockchain network 108. In the blockchain network 108, the data packet may be updated for the given data file. Spam percentages for all data files may be periodically updated on all the connected devices 102, 102a, 102b etc., in the blockchain network 108. The spam percentage of the data file may be derived from the number of spam-marked flags in all transaction block, and a color for the spam level indicator may be determined from the calculated spam percentage. For example, If the total number of users is ‘x’ and the total number of spam marked flags is ‘y’, then the spam percentage may be calculated as ‘y/x*100’=z %, but is not limited thereto. Based on the value of ‘z’, the color of the spam level indicator may be changed in the GUI of the receiver electronic devices 102a, 102b, 102c etc. A user or electronic device finds infelicitous content in the data file and a flag is spam-marked in a transaction block, so a spam level of the data file may be calculated by backtracking all the spam-marked flags in the blockchain network 108.

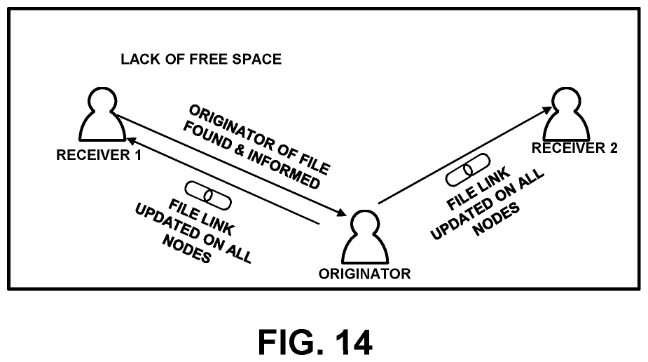

FIG. 14 illustrates an example use case of space management using a blockchain network, according to an embodiment of the disclosure.

Referring to FIG. 14, the space management using the blockchain network 108 may be utilized to avoid data redundancy when users uploading same file on cloud or secondary storage. In an embodiment, following operations may be performed for the space management. The sender may upload a data file on cloud or secondary storage, set a 3rd bit of a flag to 1 and add a file link to a data packet. In future, if anyone else tries to upload the same file on cloud, it is backtracked in blockchain network 108 and the previous file link may be shared to avoid data redundancy instead of storing the same file again. If a memory of any electronic device 102, 102a, 102b, or 102c in the blockchain network 108 is full, its memory space may be optimized by deleting files which have been uploaded to the cloud and for which a file links is generated in the blockchain network 108. If a particular data file is uploaded to the blockchain network 108 a plurality of times beyond a threshold, the received data file may be uploaded to a shared space and corresponding link may be updated in all transaction blocks in the blockchain network 108. If no shared space exists for a particular user having the data file, the data file may be deleted from the particular user's electronic device and a link to the data file of the originator or the first electronic device 102 may be generated. According to an embodiment, space is be saved because a single data file may be shared a plurality of times through the blockchain network 108.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the scope of the embodiments as described herein.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claim is:

1. A method comprising:
encoding, at an electronic device in a blockchain network, at least one portion of data to be transmitted to another electronic device;
generating a packet based on the data including the encoded at least one portion of the data; and
transmitting the packet from the electronic device to the other electronic device,
wherein a transaction block recorded on the blockchain network is updated based on a transaction information regarding the transmission of the packet, and
wherein the transaction information comprises forward-lock information for indicating whether the at least one portion of the data is forward-locked.

2. The method of claim 1, wherein the at least one portion of the data is forward-locked through a graphic user interface (GUI) displayed at the electronic device.

3. The method of claim 1, wherein the encoding of the at least one portion of the data comprises:
dividing the at least one portion of the data into a plurality of sub-portions, and
encoding the at least one portion of the data by changing a sequence of the plurality of sub-portions.

4. The method of claim 1,
wherein the at least one portion of the data is encoded using a key, and
wherein the key is associated with at least one of the electronic device and the other electronic device.

5. The method of claim 4, wherein the key is encrypted by a private key of the electronic device and a public key of the other electronic device such that the key is decrypted at the other electronic device by a public key of the electronic device and a private key of the other electronic device.

6. The method of claim 1, wherein the transaction information comprises spam information for indicating whether the data amounts to spam.

7. The method of claim 6,
wherein the spam information is marked by the other electronic device receiving the data in the blockchain network, and
wherein a spam level of the data is determined based on the transaction block.

8. The method of claim 1, wherein the transaction information comprises a link to the data stored in a cloud.

9. An electronic device, comprising:
a memory storing instructions; and
at least one processor configured to execute the instructions to:
encode, at the electronic device in a blockchain network, at least one portion of data to be transmitted to another electronic device,
generate a packet based on the data including the encoded at least one portion of data to be transmitted to the other electronic device, and
transmit the packet from the electronic device to the other electronic device,
wherein a transaction block recorded in the blockchain network is updated based on a transaction information regarding the transmission of the packet, and the transaction information comprises forward-lock information for indicating whether the at least one portion of the data is forward-locked.

10. A non-transitory computer-readable recording medium having an executable program recorded thereon, wherein the executable program instructs a computer to perform the method of claim 1.

11. A method comprising:
receiving, at an electronic device in a blockchain network, a packet transmitted from another electronic device;
obtaining, from a transaction block recorded on the blockchain network, transaction information regarding the transmission of the packet;
decoding, based on the transaction information, encoded at least one portion of data from the packet; and
performing an action on the at least one portion of the data based on a result of the decoding,
wherein the transaction information comprises forward-lock information for indicating whether the at least one portion of the data is forward-locked.

12. The method of claim 11, wherein the decoding of the encoded at least one portion of the data comprises:
decoding the at least one portion of the data by changing a sequence of a plurality of sub-portions forming the at least one portion of the data.

13. The method of claim 12, wherein the changed sequence of the plurality of sub-portions comprises an original sequence of the plurality of sub-portions before the at least one portion of the data is encoded.

14. The method of claim 11,
wherein the at least one portion of the data is decoded using a key, and
wherein the key is associated with at least one of the electronic device or the other electronic device.

15. The method of claim 14, wherein the key, which is encrypted by a private key of the other electronic device and a public key of the electronic device, is decrypted at the other electronic device by a public key of the other electronic device and a private key of the electronic device.

16. The method of claim 11, wherein the performing of the action on the at least one portion of the data comprises:
performing an action on a remainder of the data except the at least one portion of the data, based on a result of the decoding.

17. The method of claim 11,
wherein the transaction information comprises spam information for indicating whether the data amounts to spam, and
wherein a spam level of the data determined based on the transaction block is displayed.

18. The method of claim 11, wherein the transaction information comprises a link to the data stored in a cloud.

19. A non-transitory computer-readable recording medium having an executable program recorded thereon, wherein the executable program instructs a computer to perform the method of claim 11.

20. An electronic device, comprising:
a memory storing instructions; and
at least one processor configured to execute the instructions to:
receive, at the electronic device in a blockchain network, a packet transmitted from another electronic device,
obtain, from a transaction block recorded on the blockchain network, transaction information regarding the transmission of the packet,
decode, based on the transaction information, encoded at least one portion of data from the packet, and
perform an action on the at least one portion of the data based on a result of the decoding,
wherein the transaction information comprises forward-lock information for indicating whether the at least one portion of the data is forward-locked.
